(19) United States
(12) Patent Application Publication
(10) Pub. No.: US 2017/0084188 A1
(43) Pub. Date: Mar. 23, 2017

(54) PROVIDING CONTEXT TO A QUESTION

(71) Applicant: FUJITSU LIMITED, Kawasaki-shi (JP)

(72) Inventors: Yuko OKUBO, Berkeley, CA (US); Ajay CHANDER, San Francisco, CA (US)

(21) Appl. No.: 14/857,734

(22) Filed: Sep. 17, 2015

(51) Int. Cl. G09B 7/04; G09B 7/02

(52) U.S. Cl. CPC G09B 7/04; G09B 7/02

(57) ABSTRACT

The present disclosure may include a method of providing context to a question. The method may include obtaining an annotated question that includes a question variable as part of the annotated question. The question variable may include an attribute defining an information category that correspond with the question variable. The method may also include receiving real-time student-specific data of social media data, data from a biological sensor connected to the student, or GPS location, parsing the student-specific data to determine a subset of the student-specific data that belongs to the information category that corresponds with the question variable, and retrieving a context value from the subset of the student-specific data. The method may also include automatically generating a finalized question by replacing the question variable in the annotated question with the context value. The method may be performed for multiple students such that each student has a different finalized question.

### FIELD

The embodiments discussed in the present disclosure are related to providing context to a question.

### BACKGROUND

Education is a foundation for many individuals in their careers, employment, and/or life aspirations. However, some students lack motivation to engage in a meaningful way in their education. Part of the lack of motivation for some students may be due to a perceived lack of real-world applications for the material they are studying.

The subject matter claimed in the present disclosure is not limited to embodiments that solve any disadvantages or that operate only in environments such as those described above. Rather, this Background Section is provided to illustrate an example technology area where embodiments described in the present disclosure may be practiced.

### SUMMARY

One or more embodiments of the present disclosure may include a method of providing context to a question. The method may include obtaining an annotated question that includes a question variable as part of the annotated question. The question variable may include an attribute defining an information category that correspond with the question variable. Obtaining the annotated question may include receiving a standard question, parsing the standard question word by word to determine a portion of the standard question to be replaced with a context value, determining the attribute of the question variable based on the portion of the standard question to be replaced with the context value, and replacing the portion of the standard question with the question variable based on the determination of the portion to be replaced in order to derive the annotated question. The method may also include operations performed for a first student, including receiving real-time first student-specific data of a first student from one of social media data, a first biological sensor connected to the first student, or a first global positioning system (GPS), and parsing the real-time first student-specific data to determine a first subset of the real-time first student-specific data that belongs to the information category that corresponds with the question variable. The operations performed for the first student may also include retrieving a first context value from the first subset of the real-time first student-specific data and automatically generating a first finalized question by replacing the question variable in the annotated question with the first context value, the first context value selected based on the information category. The operations performed for the first student may additionally include providing the first finalized question to the first student and electronically storing a first response of the first student to the first finalized question to be used in a later question. The method may also include operations performed for a second student, including receiving real-time second student-specific data of a second student from one of social media data, a second biological sensor connected to the second student, or a second GPS, and parsing the real-time second student-specific data to determine a second subset of the real-time second student-specific data that belongs to the information category that corresponds with the question variable. The operations performed for the second student may also include retrieving a second context value from the second subset of the real-time second student-specific data, and automatically generating a second finalized question by replacing the question variable in the annotated question with the second context value, the second context value selected based on the information category. The operations performed for the second student may also include providing the second finalized question to the second student, and electronically storing a second response of the second student to the second finalized question to be used in the later question. In the method, the first finalized question and the second finalized question may be electronically generated simultaneously and may be different based on differences between the real-time first student-specific data and the real-time second student-specific data.

The object and advantages of the embodiments will be realized and achieved at least by the elements, features, and combinations particularly pointed out in the claims.

Both the foregoing general description and the following detailed description provide examples and are explanatory and are not restrictive.

### BRIEF DESCRIPTION OF THE DRAWINGS

Example embodiments will be described and explained with additional specificity and detail through the use of the accompanying drawings in which:

FIG. 1 is a diagram of an example system configured to provide context to a question;

FIG. 2 is a block diagram of an example system configured to provide context to a question;

FIG. 3 illustrates an example of an annotated question and corresponding information categories;

FIG. 4 is an example of a question provided with context;

FIGS. 5A and 5B are an example of a question provided with context;

FIG. 6 is a block diagram of an example system configured to context to a question;

FIG. 7 is a flow chart of an example method of providing context to a question;

FIG. 8 is a flow chart of an example method of generating an annotated question; and

FIGS. 9A and 9B are a flow chart of another example method of providing context to a question.

### DESCRIPTION OF EMBODIMENTS

One or more embodiments of the present disclosure may relate to providing context to a question. By providing context to a question, a story that is more engaging and interesting to a student may be crafted around the question than a question without context. Providing a question with context may encourage students to be more actively engaged in their studies. Creating a question with such a context-based story may rely on any of a variety of student-specific data and generic data. For example, in some embodiments, the context may rely on social media data of the student like FACEBOOK® posts or TWITTER® tweets, topics of interest to the student like career aspirations, personal information of the student like their age or family situation, circumstantial data like the local weather or current time, biological sensor data of a sensor connected to the student, etc. Context values providing details of a question may be provided by such data.

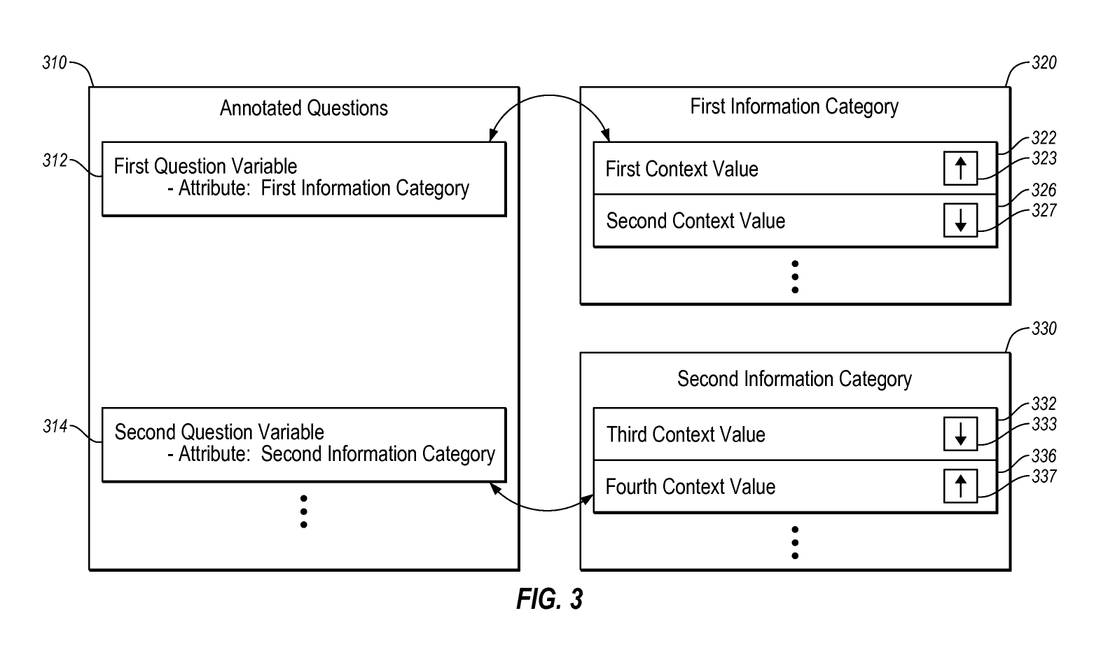

In some embodiments, to provide context to a question, an annotated question may be used. An annotated question may be a question having one or more parts of the question that may be customizable by incorporating context values. The customizable parts of the annotated question may be designated by question variables. The question variables may be placeholders in the annotated question to be removed and/or replaced by context values. The question variables may include an attribute that defines an information category that corresponds with the question variable. For example, a question variable may be replaced with a time of day and the attribute of that question variable may signify that the information category for that question variable is a time. An example of an annotated question with question variables and corresponding information categories and context values may be discussed in greater detail with respect to any one of FIGS. 3, 4, 5A, and/or 5B.

In some embodiments, the student-specific data may be parsed to determine subsets of the student-specific data that contain context values that may correspond to the information categories of the question variables. Following the example above, subparts of the student-specific data relating to the information category of times of day may be parsed out. The context values may be retrieved from the subsets of data. The retrieved context values may replace the question variables, generating a finalized question. For example, a time of day of 4:30 PM may be retrieved from a subset of the student-specific data and may replace a question variable with an attribute defining the information category as time. The finalized question may have the context value of 4:30 PM in the question. A finalized question may be a question that has been customized to the particular student.

Embodiments of the present disclosure are explained with reference to the accompanying drawings.

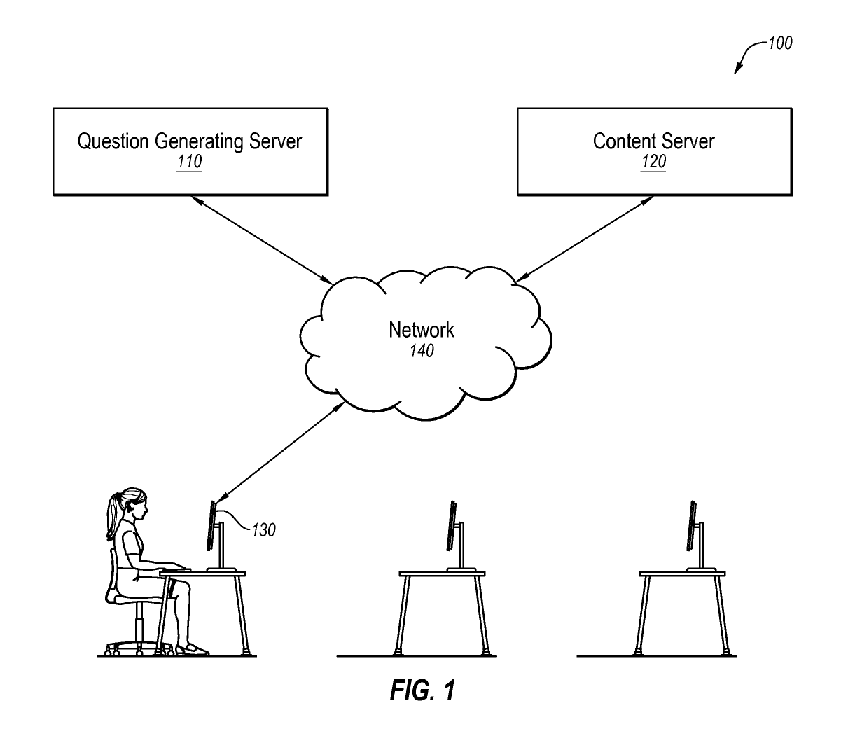

FIG. 1 is a diagram of an example system 100 configured to provide context to a question. The system 100 may include a question generating server 110, a content server 120, a student device 130, and a network 140. The question generating server 110 may utilize an annotated question with one or more question variables in the annotated question. The question generating server 110 may be configured to pull or receive context values from the content server 120 to replace the question variables in the annotated question to generate a finalized question. The question variables may include an attribute that may define an information category to which the question variable corresponds. The information category may include the type of context value that may replace the question variable such that the annotated question still makes logical sense or such that the finalized question reads properly. For example, if the question variable were holding a place for a time of day and the question variable was replaced with a name of a pet, the final question may be illogical. After generating the finalized question, the finalized question may be communicated from the question generating server 110 to the student device 130 for presentation to a student.

The network 140 may include any device, system, component, or combination thereof configured to provide communication between one or more of the question generating server 110, the content server 120, and/or the student device 130. By way of example, the network 140 may include one or more wide area networks (WANs) and/or local area networks (LANs) that enable the question generating server 110, the content server 120, and/or the student device 130 to be in communication. In some embodiments, the network 140 may include the Internet, including a global internetwork formed by logical and physical connections between multiple WANs and/or LANs. Alternately or additionally, the network 140 may include one or more cellular RF networks and/or one or more wired and/or wireless networks such as, but not limited to, 802.xx networks, Bluetooth access points, wireless access points, IP-based networks, or the like. The network 140 may also include servers that enable one type of network to interface with another type of network.

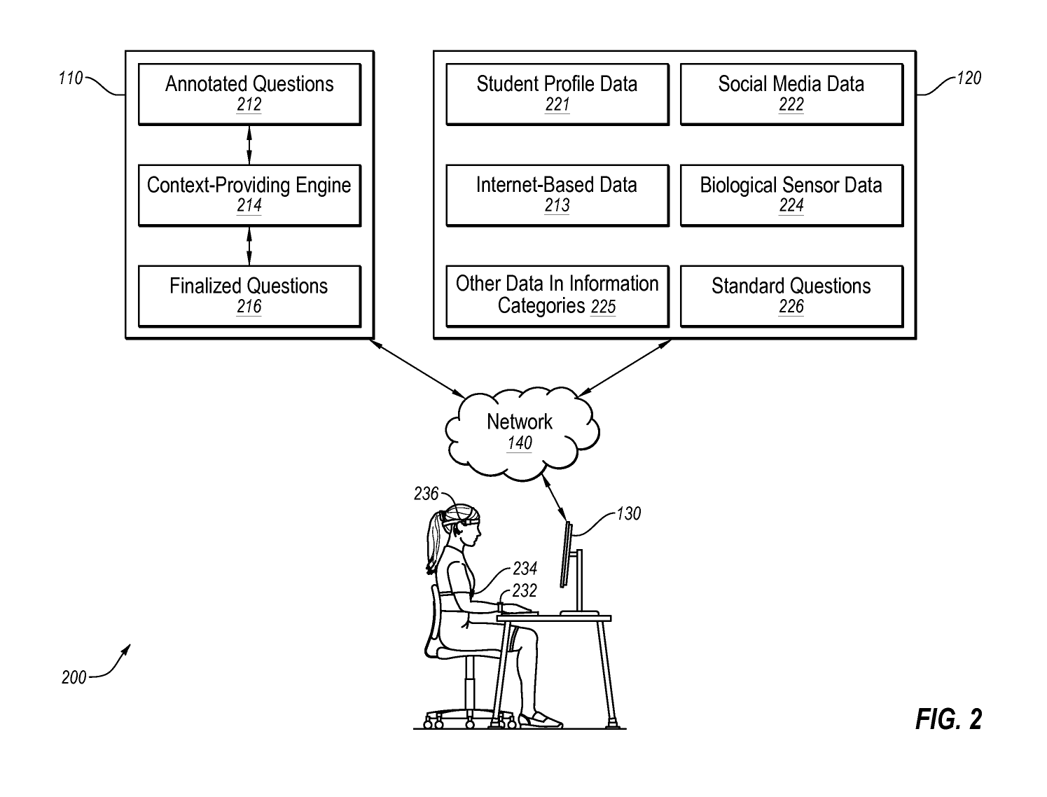

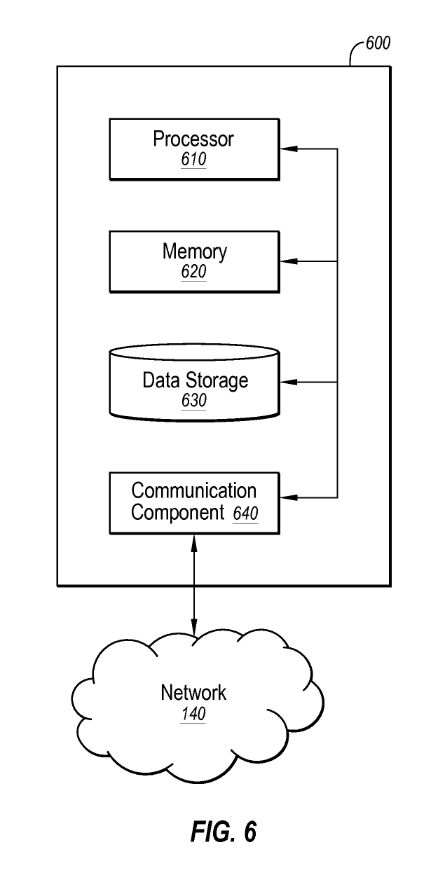

The operation of the question generating server 110, the content server 120, the student device 130, and/or the network 140 may be described in greater detail in FIG. 2. An example of the physical implementation of the question generating server 110, the content server 120, and/or the student device 130 may be described in greater detail in FIG. 6.

Modifications, additions, or omissions may be made to FIG. 1 without departing from the scope of the present disclosure. For example, the system 100 may include more or fewer elements than those illustrated and described in the present disclosure. For example, in some embodiments, the question generating server 110 and the content server 120 may be a single device or single entity.

FIG. 2 is a block diagram of an example system 200 configured to provide context to a question. The system 200 may include the question generating server 110 of FIG. 1, the content server 120 of FIG. 1, the student device 130 of FIG. 1, and the network 140 of FIG. 1.

The question generating server 110 may include annotated questions 212, a context-providing engine 214, and finalized questions 216. The annotated questions 212 may be stored in a database, data storage, or other repository. The question generating server 110 may provide one or more of the annotated questions 212 to the context-providing engine 214. In some embodiments, the question generating server 110 may obtain the annotated questions 212 without storing the annotated questions 212 and may provide the annotated questions 212 directly to the context-providing engine 214.

The context-providing engine 214 may include any system, device, component, routine, program, or combinations thereof that may obtain one or more of the annotated questions 212, replace the question variables within the annotated questions 212 with context values, and produce the finalized questions 216. Additionally or alternatively, in some embodiments, the context-providing engine 214 may be configured to generate one or more of the annotated questions 212.

In operation, the context-providing engine 214 may begin at a first word or phrase of a particular annotated questions 212 and may proceed through the particular annotated question 212 until the context-providing engine 214 arrives at a question variable including an attribute that defines an information category corresponding with the question variable. After the context-providing engine 214 arrives at a question variable, the context-providing engine 214 may determine the information category of the attribute. After determining the information category, the context-providing engine 214 may request, pull, or otherwise receive a context value that corresponds with the information category. For example, the context-providing engine 214 may send a message to the content server 120 including a request for a context value corresponding to the information category of the question variable.

Additionally or alternatively, the context-providing engine 214 may parse one or more data sources to determine subsets of data that belong to the category of information. For example, the context-providing engine 214 may parse social media data like a FACEBOOK® post of the student to determine subsets of the FACEBOOK® post that belong to the category of information by searching for keywords or other indicia of the category of information. The context-providing engine 214 may retrieve a context value from the subset of the data.

After receiving the context value, the context-providing engine 214 may replace the question variable with the context value. The context-providing engine 214 may proceed through the rest of the annotated question for any remaining question variables and also replace the question variables with context values.

By proceeding through the particular annotated question, the context-providing engine 214 may generate a finalized question that corresponds to the particular annotated question. In some embodiments, the context-providing engine 214 may be configured to generate one or more finalized questions that may each be based on one or more annotated questions. The finalized questions 216 may be stored in a database, data storage, or other receptacle, or may be immediately communicated to the student device 130 without being stored. The finalized questions 216 may include annotated questions 212 that have had their question variables replaced with context values.

The content server 120 may include stored thereon one or more of the categories of data illustrated in FIG. 2. For example, the content server 120 may include student profile data 221, social media data 222, Internet-based data 223, biological sensor data 224, and/or other data in information categories 225. The content server 120 may also store standard questions 226.

The categories of data illustrated are merely examples and there may be more or less than the categories of data illustrated. Additionally, there may be overlap between certain categories, and data may be associated with either or both of the categories. The content server 120 may store or maintain the data in information categories, may store the data without identifying an information category for the data, or combinations thereof. Additionally or alternatively, the content server 120 may parse or otherwise sort the data when a context value of a certain category is requested. For example, the content server 120 may parse social media data 222 like a FACEBOOK® post of the student to determine subsets of the FACEBOOK® post that belong to the category of information by searching for keywords or other indicia of a requested category of information.

In some embodiments, the content server 120 and/or the question generating server 110 may retrieve one or more context values from the subsets of data that may contain context values of an information category corresponding to a question variable. For example, a text value or an image may be retrieved from the subset of data. The context values may also be sorted into a particular information category. In some embodiments, the context values may be stored in association with a particular information category.

The student profile data 221 may include any information or data relating to the student. Non-limiting examples of the student profile data 221 may include: name, age, gender, grade, previous performance on questions (including previous answers to final questions with context), topics of interest to the student (e.g. books read, music listened to, subjects enjoyed in studies, sports enjoyed, activities participated in during free time, etc.), family information (e.g. father, mother, siblings, order of siblings, other relatives, including names and ages of any of the foregoing, etc.), languages (e.g. English and Japanese), residence (e.g. apartment, home, dormitory, on-campus, city and state of residence, etc.), schools (e.g. current and/or former schools), future plans (e.g. career goals or aspirations, desired employment, future schools, desired future schools, upcoming vacations, etc.), experiences of success (e.g. activities or experiences that reflected success to the student), level and/or location of education of the parents of the student, preferred learning method (e.g. visual learner, auditory learner, hands-on learner, etc.), etc.

The social media data 222 may include any information or data electronically posted in a public or semi-public manner by way of or to encourage social interaction. The social media data 222 may be gathered from any one or combination of social media sources, for example, a FACEBOOK® account, TWITTER® account, GOOGLE+® account, SNAPCHAT® account, MYSPACE® account, LINKEDIN® account, PINTEREST® account, INSTAGRAM® account, TUMBLR® account, FLICKR® account, VINE® account, YOUTUBE® account, blog, personal web page, message board, email account, etc. In some embodiments, the social media data 222 may be from other users besides the student. For example, if the student has expressed interest in baseball the social media data 222 may include TWITTER® entries from popular baseball players. By way of another example, social media entries of family members may also be included in the social media data 222.

The Internet-based data 223 may include any pertinent information or data that may be accessible on the Internet. For example, local events (e.g. sporting events, news stories, etc.), national events, local and/or national weather (e.g. wind, temperature, precipitation, humidity, barometric pressure, etc.), current time, trending materials (e.g. popular videos, stories, TWITTER® entries, etc.), schedules of events (e.g. travel itineraries, event schedules, sports team schedules, band tour dates and locations, etc.), etc.

The biological sensor data 224 may include any information or data that may be collected from one or more sensors connected to the student. For example, the student may have a first biological sensor 232, a second biological sensor 234, and a third biological sensor 236. While three sensors are illustrated, any number of sensors may be utilized. The first biological sensor 232 may be a wrist sensor that may measure biological data. The second biological sensor 234 may be a chest sensor that may measure biological data. The third biological sensor 236 may be a head sensor that may measure biological data. The first, second, and third biological sensors 232, 234, and 236 may be located anywhere on or around the student The first, second, and third biological sensors 232, 234, and 236 may be wearable technology such as an APPLE WATCH®, FITBIT®, FUELBAND®, fitness tracker, pulse oximeter, electrodes, etc. The measured biological data may include heart rate, breathing rate, blood oxygen levels, blood sugar levels, sleep activity, level of drowsiness, stress level, brain activity, etc. In these and other embodiments, the first, second, and third biological sensors 232, 234, and 236 may communicate the measured biological data to the student device 130, the content server 120, and/or the question generating server 110.

There may be other data that is pulled from other sources or utilized as context for one or more of the questions. Such other data may be stored as the other data in information categories 225. In some embodiments, the other data in information categories 225 may include default context values and/or context values from other students. In these and other embodiments, if an information category with a corresponding question variable has no context values from the student-specific data, a generic and/or other student context value may be used to replace the question variable.

In some embodiments, data may include real-time data. For example, one information category may include the current time, the current temperature, or current location of a student (e.g. from a global positioning system (GPS) of a student and/or a device of a student). As another example, another information category may include the student's current heart rate or current level of drowsiness. While the term “real-time” is used, the data gathered may be the most recent or relatively recent (e.g. thirty seconds old, one minute old, two minutes old, five minutes old, ten minutes old, twenty minutes old, two hours old, etc.) and still be considered real-time data.

In these and other embodiments, the information category may specify a timeframe within which the context value may fall. For example, an information category may request weather but limit the context value to weather within the last three days, or as another example, an information category may request a sports figure but limit the context value to a sports figure who has been in a news headline within the last four hours. In some embodiments, the real-time data may be the social media data 222, the Internet-based data 223, and/or the biological sensor data 224.

In some embodiments, the content server 120 and/or the question generating server 110 may derive an annotated question starting with the standard questions 226. For example, the content server 120 and/or the question generating server 110 may parse a standard question to determine a portion of the standard question that may be replaced with a context value (e.g. a portion that may be customized or changed and still make logical sense in the question). For example, proper names, times, dates, activities, etc. may be replaced with context values to create a customized question. The content server 120 and/or the question generating server 110 may also determine an attribute for a question variable that may take the place of the portion of the standard question. For example, the content server 120 and/or the question generating server 110 may analyze surrounding language of the standard question to find an information category to which the context value may belong. The content server 120 and/or the question generating server 110 may also replace the portion of the standard question that may be customizable with the question variable, thus deriving an annotated question. The annotated question may be one of the annotated questions 212 and/or may be communicated to the question generating server 110. The question generating server may utilize the annotated question as described in the present disclosure.

In some embodiments, the content server 120 and/or the question generating server 110 may sort the context values into information categories. In these and other embodiments, the context values may also be sorted based on interest rankings of the context values. For example, for two context values belonging to the same information category, the context value with the higher interest ranking may be sorted higher than the context value with the lower interest ranking.

Modifications, additions, or omissions may be made to FIG. 2 without departing from the scope of the present disclosure. For example, the system 200 may include more or fewer elements than those illustrated and described in the present disclosure. For example, in some embodiments, any number of data categories may be included in the content server 120. For example, in some embodiments annotated questions may be stored on the content server 120. Additionally or alternatively, in some embodiments one or more operations described as being performed by the content server 120, or the question generating server 110 may be performed at or by the student device 130.

FIG. 3 illustrates an example of an annotated question 310 and corresponding information categories (for example, a first information category 320 and a second information category 330). The annotated question 310 may include a question for a student. The annotated question 310 may include one or more question variables that may be replaced with context values to create a finalized question. In the illustrated example, the annotated question 310 may include a first question variable 312 and a second question variable 314. While two question variables are illustrated, the ellipses below the second question variable 314 signifies that there may be any number of question variables within the annotated question 310.

The first question variable 312 may include an attribute defining the first information category 320 as corresponding with the first question variable 312. By using the attribute, the first question variable 312 may be replaced with a context value from the first information category 320. The second question variable 314 may include an attribute defining the second information category 330 as corresponding with the second question variable 314. By using the attribute, the second question variable 314 may be replaced with a context value from the second information category 330.

The first information category 320 may include one or more context values such as a first context value 322 and a second context value 326. While two context values are illustrated, the ellipses below the second context value 326 signifies that there may be any number of question variables within first information category 320. In some embodiments, the first context value 322 may include an interest ranking 323 and the second context value 326 may include an interest ranking 327.

The second information category 330 may include one or more context values such as a third context value 332 and a fourth context value 336. While two context values are illustrated, the ellipses below the fourth context value 336 signifies that there may be any number of question variables within the second information category 330. In some embodiments, the third context value 332 may include an interest ranking 333 and the fourth context value 336 may include an interest ranking 337.

In some embodiments, the interest rankings 323 and 327 may be used to select a context value when multiple context values are within the first information category 320. For example, when the first question variable 312 is to be replaced with a context value from the first information category 320, the first information category 320 may have both the first context value 322 and the second context value 326. Based on the higher interest ranking 323 (illustrated by the upward arrow) of the first context value 322 compared to the interest ranking 327 of the second context value 326, the first context value 322 may replace the first question variable 312. Similarly with respect to the second question variable 314, based on the higher interest ranking 337 (illustrated by the upward arrow) of the fourth context value 336 compared to the interest ranking 333 of the third context value 332 in the second information category 330, the fourth context value 336 may replace the second question variable 314.

The interest rankings 323, 327, 333, and 337 may be based on any number of factors that may lead to precedence of one context value over another. For example, the interest rankings 323, 327, 333, and 337 may be based on any of how recent in time the context value or the subset of data from which the context value was derived was generated, a relation of the context value to a topic selected by a student as interesting, a topic frequently viewed and/or commented on by the student, how frequently the context value occurs in other student-specific data, or any combinations thereof.

Modifications, additions, or omissions may be made to FIG. 3 without departing from the scope of the present disclosure. For example, there may be any number of question variables in a given annotated question, there may be any number of information categories, and there may be any number of context values in any given information category.

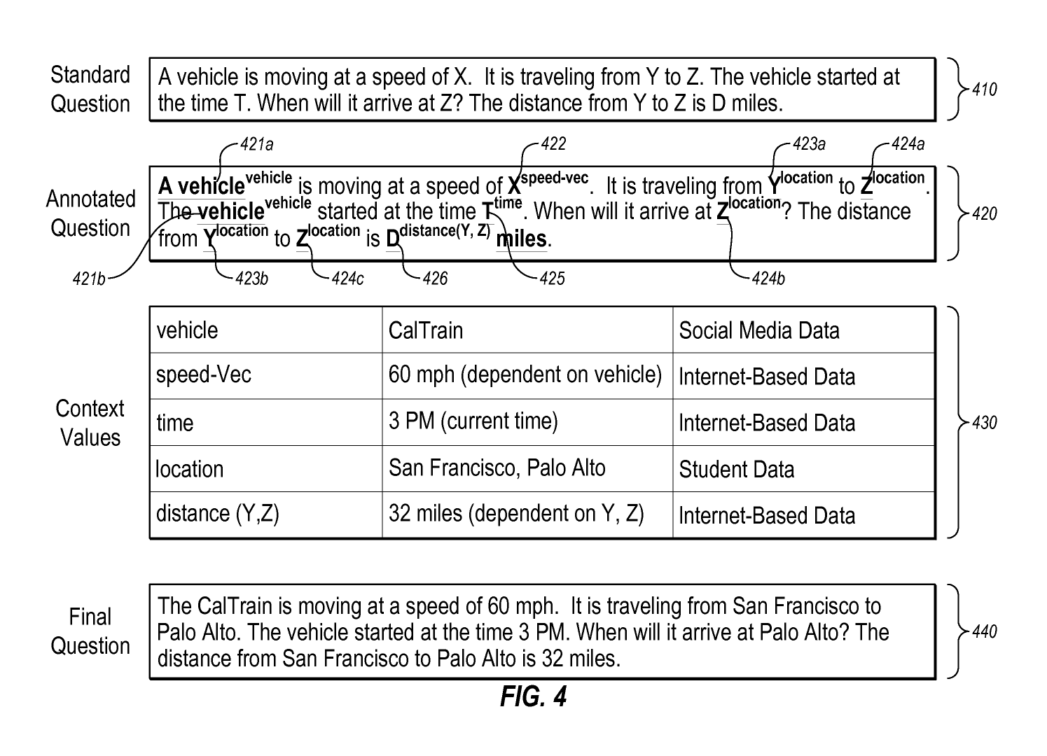

FIG. 4 is an example of a question provided with context. For example, FIG. 4 may illustrate a standard question 410, an annotated question 420, context values 430, and a final question 440. The example of FIG. 4 is in no way meant to be limiting.

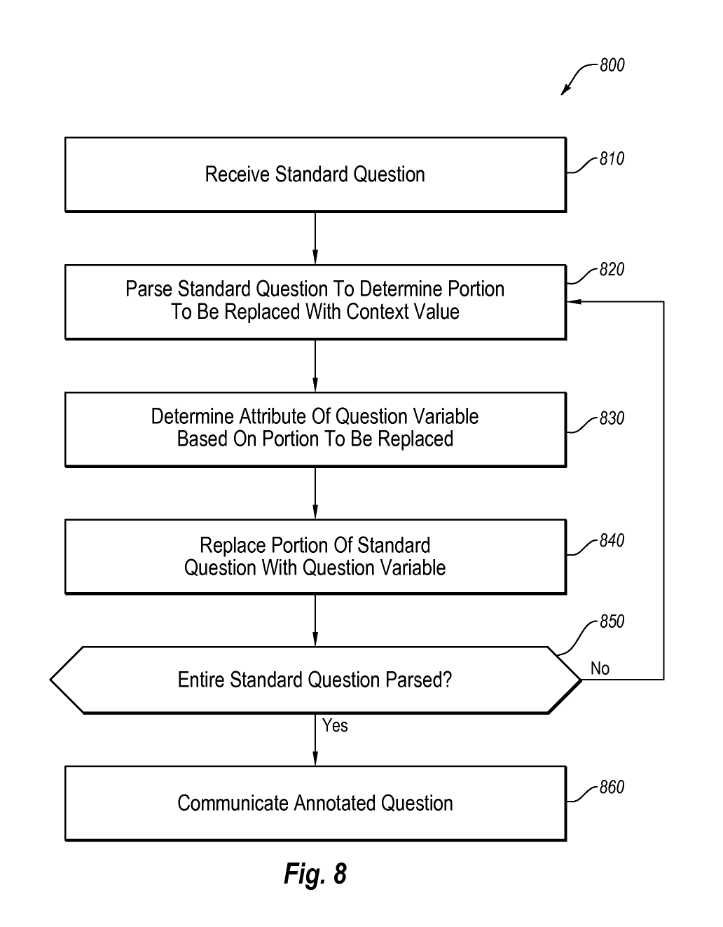

The standard question 410 may not have any annotations or question variables within the language of the standard question 410. The standard question 410 may be converted to the annotated question 420 as described in the present disclosure, for example, as described in FIG. 8. Alternatively, a publisher, educator, producer, or other question-producing entity may produce the standard question 410 and/or the annotated question 420.

The annotated question 420 may include multiple question variables. For the sake of the example of FIG. 4, the question variables may include a first question variable 421a (“A vehicle”) with a corresponding information category of “vehicle,” a second question variable 422 (“X”) with a corresponding information category of “speed-vec,” a third question variable 423a (“Y”) with a corresponding information category of “location,” a fourth question variable 424a (“Z”) with a corresponding information category of “location,” a fifth question variable 425 (“T”) with a corresponding information category of “time,” and a sixth question variable 426 (“D”) with a corresponding information category of “distance(Y, Z).”

The context values 430 may include the information category, the context value, and the source of the context value. For example, “CalTrain” may be in the “vehicle” information category and may be derived from social media data, as another example, “3 PM” may be in the “time” information category and may be derived from Internet-based data. The visual depiction of the context values 430 is an example and is in no way limiting. The context values 430 may include more or less information than is illustrated in FIG. 4, for example, the context values 430 may include the student associated with the context value, question variables corresponding to the information category, etc.

In some embodiments, there may exist dependencies between context values. For example, one context value may be a sub-value of another. By way of example, the context value “CalTrain” of the “vehicle” information category may include a dependent value “60 mph.” The dependent context value may be stored as a separate information category or may be a sub-information category of the context value upon which the dependent context value depends. For example, the “speed-vec” information category may be a sub-information category of the “vehicle” information category. As another example of a dependency, the context value of the “distance(Y, Z)” information category may be dependent on the context values used to replace the question variables of “Y” and “Z.” In these and other embodiments, a dependency between context values may override or take precedence over an interest ranking. For example, if “CalTrain” had been selected to replace the first question variable 421a, even if a context value with a higher interest ranking may be present in the “speed-vec” information category, the “60 mph” context value may be selected based on the dependency between the “60 mph” context value and the “CalTrain” context value.

In some embodiments, messages requesting context values may include identification of any dependency associated with the context value being requested. Such a message may also include any previous context values used and/or previous question variables involved in the dependency. In some embodiments, dependencies may override an interest ranking. Additionally or alternatively, a dependency may be a factor affecting an interest ranking, such as setting an interest ranking as the highest ranking for an information category.

As illustrated in FIG. 4, by replacing the first question variables 421a and 421b, the second question variable 422, the third question variables 423a and 423b, the fourth question variables 424a, 424b, and 424c, the fifth question variable 425, and the sixth question variable 426 with the corresponding context values of the respective information categories, the final question 440 may be generated.

Modifications, additions, or omissions may be made to FIG. 4 without departing from the scope of the present disclosure. For example, there may be any number of question variables in a given annotated question, there may be any number of information categories, and there may be any number of context values in any given information category.

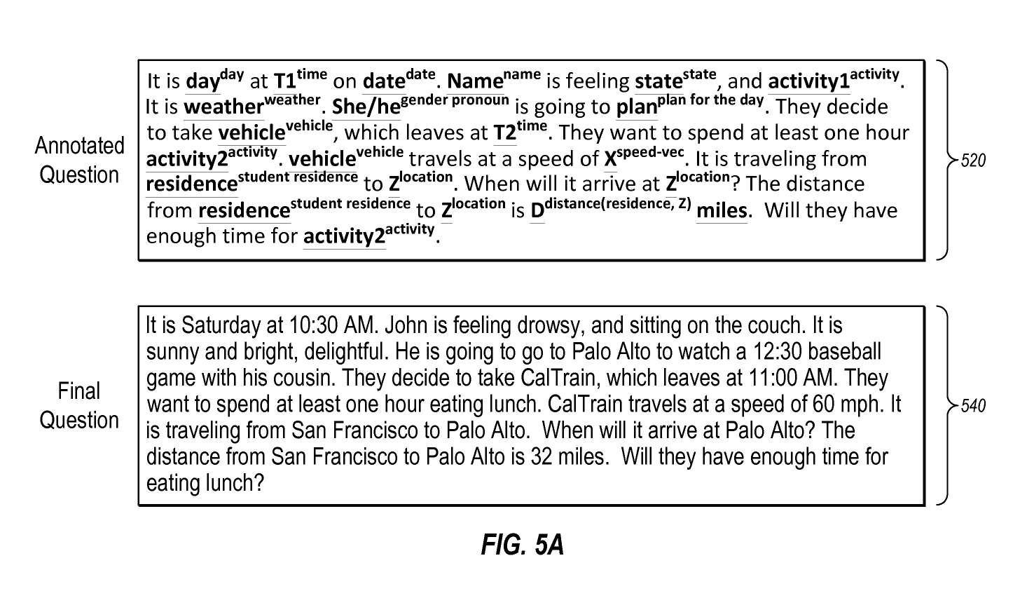

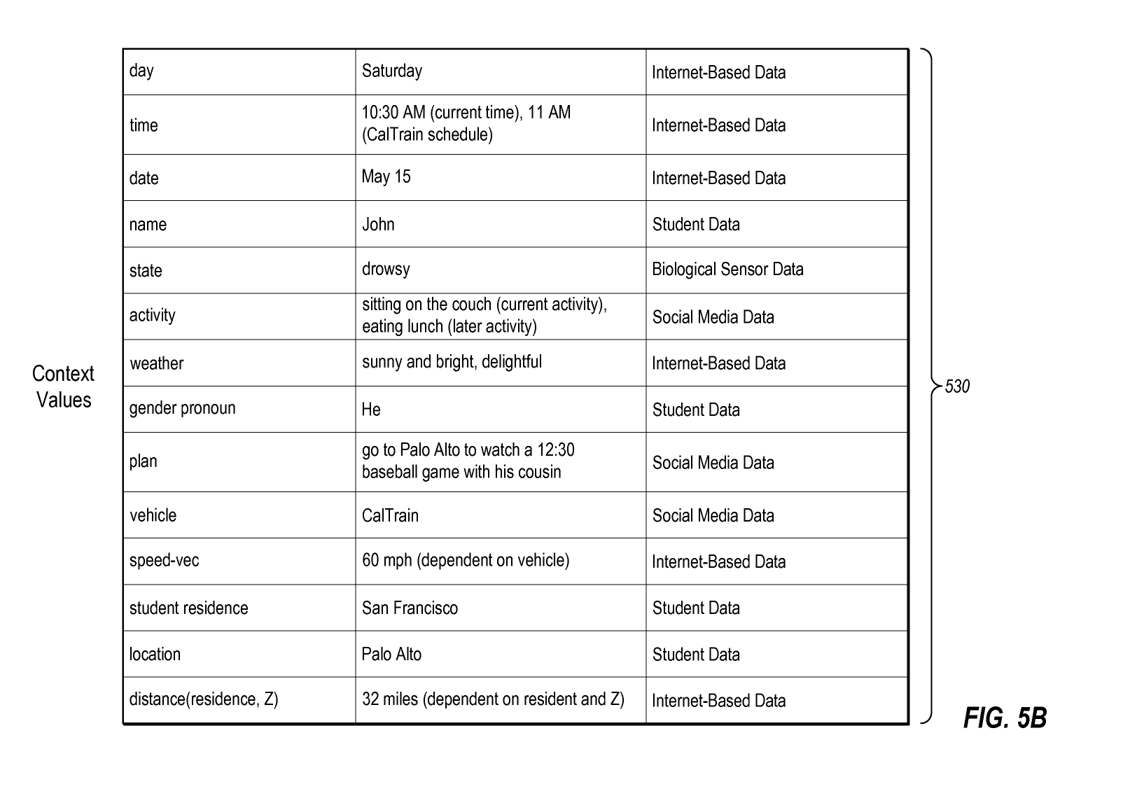

FIGS. 5A and 5B are an example of a question provided with context. For example, FIGS. 5A and 5B may illustrate a standard question 510, an annotated question 520, context values 530, and a finalized question 540. The example of FIGS. 5A and 5B is no way meant to be limiting. FIGS. 5A and 5B illustrate a more complex example than the example of FIG. 4, and serves to illustrate principles in accordance with the present disclosure.

As illustrated in FIGS. 5A and 5B, the annotated question 520 may include multiple question variables, the question variables including an attribute designating a corresponding information category. The context values 530 may replace the question variables in the annotated question 520 such that the context values 530 may become part of the language and/or presentation of the annotated question 520. By replacing the question variables with the context values 530, the finalized question 540 may be generated from the annotated question 520.

As compared to the example of FIG. 4, FIGS. 5A and 5B illustrate various additional data categories and information categories. The example of FIGS. 5A and 5B illustrates that a question similar to that used in the example of FIG. 4 may be provided with further customization by including additional question variables. In some embodiments, by providing greater customization and/or greater context to the question that is specifically tailored to the student, the example provided in FIGS. 5A and 5B may be more engaging to a student.

In some embodiments, portions of the annotated question 520 may be dropped from the finalized question 540. Some question variables may be designated as core question variables while others may be designated as ancillary question variables. For ancillary question variables, associated material in the annotated question 520 may also be designated as removable from the annotated question 520. In these and other embodiments, if the information category corresponding to a core question variable has no context values, the question may be skipped, a default or generic value may be used, or a context value from another student may be used.

Modifications, additions, or omissions may be made to the example of FIGS. 5A and 5B without departing from the scope of the present disclosure. For example, there may be any number of question variables in a given annotated question, there may be any number of information categories, and there may be any number of context values in any given information category.

FIG. 6 is a block diagram of an example system configured to provide context to a question. The system may include a device 600 that may operate as a computing device and may be in communication with a network 140. For example, the device 600 may include a desktop computer, a laptop computer, a tablet computer, a mobile phone, a smartphone, a personal digital assistant (PDA), an e-reader device, server, blade server, rack mounted server, cluster of servers, or other suitable computer device. The network 140 may be similar or identical to the network 140 of FIG. 1 and FIG. 2. Any of the question generating server 110, the content server 120, and/or the student device 130 may be implemented as the device 600.

The device 600 may include a processor 610, a memory 620, a data storage 630, and a communication component 640. The processor 610, the memory 620, the data storage 630, and/or the communication component 640 may all be communicatively coupled such that each of the components may communicate with the other components. The device 600 may be configured to perform any of the operations described in the present disclosure.

In general, the processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 6, the processor 610 may include any number of processors configured to perform, individually or collectively, any number of operations described in the present disclosure.

In some embodiments, the processor 610 may interpret and/or execute program instructions and/or process data stored in the memory 620, the data storage 630, or the memory 620 and the data storage 630. In some embodiments, the processor 610 may fetch program instructions (e.g., stored as a context-providing engine, such as the context-providing engine 214 described with respect to FIG. 2) from the data storage 630 and load the program instructions in the memory 620. After the program instructions are loaded into memory 620, the processor 610 may execute the program instructions.

The memory 620 and the data storage 630 may include computer-readable storage media for carrying or having computer-executable instructions or data structures stored thereon. Such computer-readable storage media may include any available media that may be accessed by a general-purpose or special-purpose computer, such as the processor 610. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 610 to perform a certain operation or group of operations.

The communication component 640 may include any device, system, component, or collection of components configured to allow or facilitate communication between the device 600 and the network 140. For example, the communication component 640 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a WiFi device, a WiMax device, cellular communication facilities, etc.), and/or the like. The communication component 640 may permit data to be exchanged with any network (including the network 140) such as a cellular network, a WiFi network, a MAN, an optical network, etc., to name a few examples, and/or any other devices described in the present disclosure.

Modifications, additions, or omissions may be made to FIG. 6 without departing from the scope of the present disclosure. For example, the device 600 may include more or fewer elements than those illustrated and described in the present disclosure.

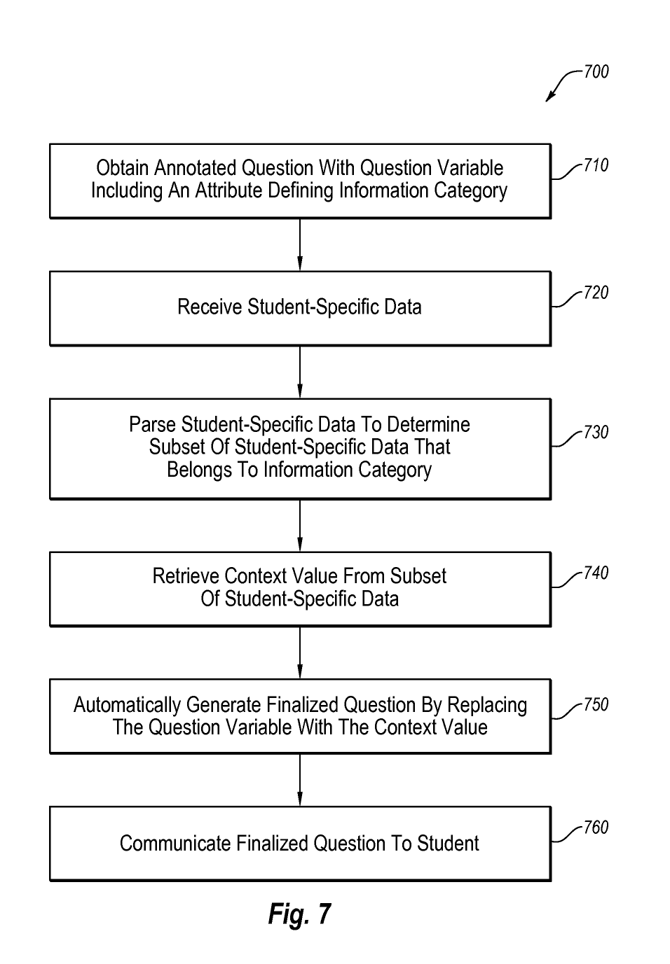

FIG. 7 is a flow chart of an example method 700 of providing context to a question. The method 700 may be performed by any suitable system, apparatus, or device. For example, the system 100 of FIG. 1, the question generating server 110 of FIGS. 1 and/or 2, or the system 200 of FIG. 2 may perform one or more of the operations associated with the method 700. Although illustrated with discrete blocks, the steps and operations associated with one or more of the blocks of the method 700 may be divided into additional blocks, combined into fewer blocks, or eliminated, depending on the desired implementation. Additionally or alternatively, the method 700 may be performed for multiple students such that each student may have a question customized to their particular circumstance. For example, starting with the same annotated question, a first student may have a first finalized question based on student-specific data of the first student and a second student may have a second finalized question based on student-specific data of the second student, and the first and second finalized questions may be different even though both came from the same annotated question.

At block 710, an annotated question may be obtained. The annotated question may include a question variable as part of the annotated question. The question variable may include an attribute that may define an information category associated with the question variable. In some embodiments, the annotated question may be obtained from a content server. In some embodiments, obtaining an annotated question may include deriving the annotated question from a standard question, for example, as described in FIG. 8. In some embodiments, obtaining an annotated question may include receiving the annotated question, for example, from a content server or a publisher, educator, producer, or other question-producing entity. The annotated question may or may not be received in response to a request from the content server or the publisher, educator, producer, or other question-producing entity.

At block 720, student-specific data may be received. The student-specific data may be derived from any number of data categories, for example, those illustrated in the content server 120 of FIG. 2.

At block 730, the student-specific data may be parsed to determine subsets of the student-specific data that may belong to the information category corresponding to the question variable. Block 730 may be performed in response to a request for a context value in the information category corresponding to the question variable. Parsing the student-specific data may include searching for key text terms, searching for surrounding key text terms, searching for fields in the student-specific data, ignoring portions of the student-specific data known to not correspond with the information category, etc. At block 740, a context value may be retrieved from the subset of student-specific data that belong to the information category.

At block 750, a finalized question may be automatically generated by replacing the question variable with the context value. In some embodiments, the finalized question may have any question variables in the annotated question replaced with context values. At block 760, the finalized question may be communicated to the student.

Accordingly, the method 700 may be used to provide context to a question. Modifications, additions, or omissions may be made to the method 700 without departing from the scope of the present disclosure. For example, the operations of the method 700 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments. All of the examples provided above are non-limiting and merely serve to illustrate the flexibility and breadth of the present disclosure.

FIG. 8 is a flow chart of an example method 800 for generating an annotated question. The method 800 may be performed by any suitable system, apparatus, or device. For example, the system 100 of FIG. 1, the question generating server 110 of FIGS. 1 and/or 2, the content server 120 of FIGS. 1 and/or 2, or the system 200 of FIG. 2 may perform one or more of the operations associated with the method 800. Although illustrated with discrete blocks, the steps and operations associated with one or more of the blocks of the method 800 may be divided into additional blocks, combined into fewer blocks, or eliminated, depending on the desired implementation. Additionally or alternatively, the method 800 may be performed for multiple students such that each student may have a question customized to their particular circumstance. For example, starting with the same annotated question, a first student may have a first finalized question based on student-specific data of the first student and a second student may have a second finalized question based on student-specific data of the second student, and the first and second finalized questions may be different even though both came from the same annotated question.

At block 810, a standard question may be received. The standard question may not have any question variables in the language of the question. At block 820, the standard question may be parsed to determine one or more portions of the standard question that may be replaced with context values to provide context to the standard question. Parsing the standard question may include starting at the beginning of a question and analyzing each portion (e.g. a word or phrase) to identify whether that portion may be replaced. After a portion has been identified, the method 800 may proceed to block 830.

At block 830, an attribute defining an information category may be determined based on the portion to be replaced. For example, the portion to be replaced may belong to the information category, or surrounding language of the portion to be replaced may indicate the information category. At block 840, the portion of the standard question determined from block 820 may be replaced with a question variable. The question variable may include the attribute determined at block 830.

At block 850, a determination may be made whether the entire standard question has been parsed. If only a part of the standard question has been parsed, the method 800 may proceed to block 820 to continue to parse the standard question for any additional portions that may be replaced by context values. If the entire standard question has been parsed, the method 800 may proceed to block 860.

At block 860, the annotated question may be communicated, for example, to a question generating server for storage. Additionally or alternatively, the question generating server may generate a finalized question from the annotated question. The annotated question may also be stored at the content server. In these or other embodiments, the annotated question may be stored locally other than being communicated.

Accordingly, the method 800 may be used to generate an annotated question. Modifications, additions, or omissions may be made to the method 800 without departing from the scope of the present disclosure. For example, the operations of the method 800 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments. All of the examples provided above are non-limiting and merely serve to illustrate the flexibility and breadth of the present disclosure.

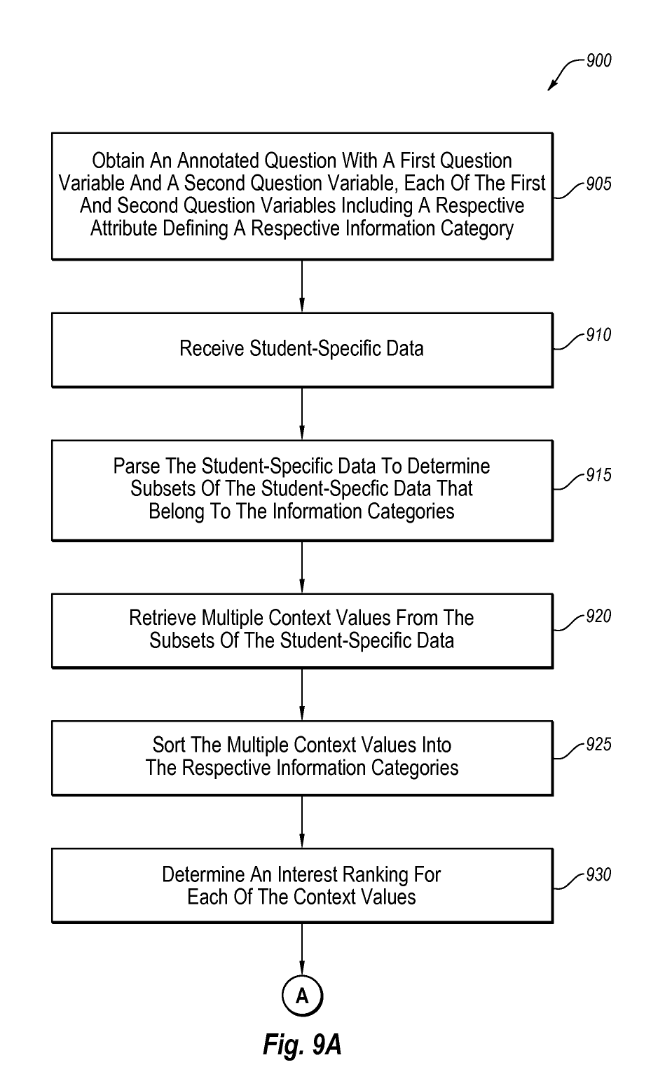

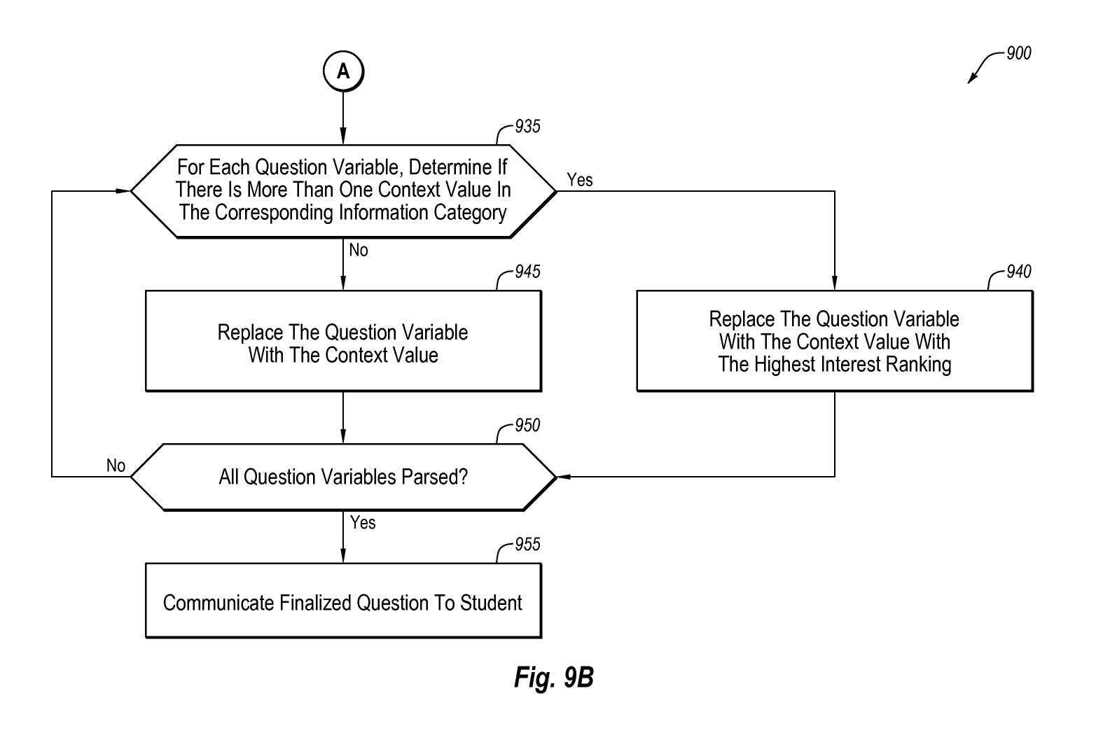

FIGS. 9A and 9B are a flow chart of another example method 900 of providing context to a question. The method 900 may be performed by any suitable system, apparatus, or device. For example, the system 100 of FIG. 1, the question generating server 110 of FIGS. 1 and/or 2, or the system 200 of FIG. 2 may perform one or more of the operations associated with the method 900. Although illustrated with discrete blocks, the steps and operations associated with one or more of the blocks of the method 900 may be divided into additional blocks, combined into fewer blocks, or eliminated, depending on the desired implementation. Additionally or alternatively, the method 900 may be performed for multiple students such that each student may have a question customized to their particular circumstance. For example, starting with the same annotated question, a first student may have a first finalized question based on student-specific data of the first student and a second student may have a second finalized question based on student-specific data of the second student, and the first and second finalized questions may be different even though both came from the same annotated question.

At block 905, an annotated question may be obtained. The annotated question may include a first question variable and a second question variable. Each of the first question variable and the second question variable may include a respective attribute that may define a respective information category. For example, the first question variable may correspond to a first information category and the second question variable may correspond to a second information category. The annotated question may be obtained in a similar manner to that described at block 710 of FIG. 7, for example, by deriving the annotated question or receiving the annotated question.

At block 910, student-specific data may be received. The block 910 may be similar to the block 720 of FIG. 7. At block 915, the student-specific data may be parsed to determine one or more subsets of the student-specific data that belong to the information categories. For example, there may be multiple subsets of the student-specific data that correspond to the first information category and there may be multiple subsets of the student-specific data that correspond to the second information category. The block 915 may be similar to the block 730 of FIG. 7.

At block 920, multiple context values may be retrieved from the subsets of the student-specific data. For example, a first and a second context value may be retrieved from one or more subsets of the student-specific data in the first information category and a third context value may be retrieved from the one or more subsets of the student-specific data in the second information category. Block 920 may be similar to the block 740 of FIG. 7.

At block 925, the multiple context values may be sorted into the respective information categories. For example, the first and the second context values may be sorted into the first information category and the third context value may be sorted into the second information category.

At block 930, an interest ranking may be determined for each of the context values. The interest ranking may be based on the student-specific data. By way of example, an interest ranking for the first context value may be determined to be higher than an interest ranking for the second context value based on the student-specific data.

At block 935 (shown on FIG. 9B), a determination may be made whether there is more than one context value in the information category corresponding to the question variable. If it is determined that there is more than one context value in the information category corresponding to the question variable, the method 900 may proceed to block 940. For example, if the first question variable corresponds to the first information category, a determination may be made as to whether the first information category has more than one context value. Following the example from above, there may be both the first context value and the second context value in the first information category and the method 900 may proceed to block 940. At block 940, the question variable may be replaced with the context value with a highest interest ranking. For example, the first context value may have a higher interest ranking than the second interest value and thus be the context value with the highest ranking, the first context value may replace the first question variable.

If it is determined at block 935 that there is one context value in the information category corresponding to the question variable, the method 900 may proceed to block 945. For example, if the second question variable corresponds to the second information category there may be one context value, the third context value, in the second information category and the method 900 may proceed to block 945. At block 945, the question variable may be replaced with the context value. For example, the second question variable may be replaced with the third context value.

At block 950, a determination may be made whether all of the question variables in the annotated question have been replaced. If it is determined there are still remaining question variables in the annotated question, the method 900 may proceed to block 935. If it is determined that all of the question variables have been replaced in the annotated question, the method 900 may proceed to block 955. Additionally, the annotated question may have become a finalized question. At block 955, the finalized question may be communicated to the student.

Accordingly, the method 900 may be used to provide context to a question. Modifications, additions, or omissions may be made to the method 900 without departing from the scope of the present disclosure. For example, the operations of the method 900 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments. All of the examples provided above are non-limiting and merely serve to illustrate the flexibility and breadth of the present disclosure.

The embodiments described herein may include the use of a special purpose or general-purpose computer including various computer hardware or software modules, as discussed in greater detail below.

Embodiments within the scope of the technology disclosed herein may also include computer-readable media for carrying or having computer-executable instructions or data structures stored thereon. Such computer-readable media may be any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium which may be used to carry or store desired program code means in the form of computer-executable instructions or data structures and which may be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above may also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” the term “containing” should be interpreted as “containing, but not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method of providing context to a question, the method comprising:
obtaining, by a question-generating server, an annotated question, the annotated question including a question variable as part of the annotated question, the question variable including an attribute defining an information category that correspond with the question variable, obtaining the annotated question comprising:
receiving a standard question;
parsing the standard question word by word to determine a portion of the standard question to be replaced with a context value;
determining the attribute of the question variable based on the portion of the standard question to be replaced with the context value; and
replacing the portion of the standard question with the question variable based on the determination of the portion to be replaced in order to derive the annotated question;
by the question-generating server and for a first student:
receiving real-time first student-specific data of a first student from one of social media data, a first biological sensor connected to the first student, or a first global positioning system (GPS);
parsing the real-time first student-specific data to determine a first subset of the real-time first student-specific data that belongs to the information category that corresponds with the question variable;
retrieving a first context value from the first subset of the real-time first student-specific data;
automatically generating a first finalized question by replacing the question variable in the annotated question with the first context value, the first context value selected based on the information category;
providing the first finalized question to the first student; and
electronically storing a first response of the first student to the first finalized question to be used in a later question;
by the question-generating server and for a second student:
receiving real-time second student-specific data of a second student from one of social media data, a second biological sensor connected to the second student, or a second GPS;
parsing the real-time second student-specific data to determine a second subset of the real-time second student-specific data that belongs to the information category that corresponds with the question variable;
retrieving a second context value from the second subset of the real-time second student-specific data;
automatically generating a second finalized question by replacing the question variable in the annotated question with the second context value, the second context value selected based on the information category;
providing the second finalized question to the second student; and
electronically storing a second response of the second student to the second finalized question to be used in the later question; and
wherein the first finalized question and the second finalized question are electronically generated simultaneously and are different based on differences between the real-time first student-specific data and the real-time second student-specific data.

2. The method of claim 1, wherein:
the annotated question includes a plurality of question variables and each of the plurality of question variables has a respective attribute defining a respective information category to which each of the plurality of question variables belongs; and
each of the plurality of question variables is replaced by one of a plurality of context values in the respective information category.

3. The method of claim 2, further comprising the question-generating server sorting the plurality of context values into a plurality of information categories, the plurality of information categories including the respective information category.

4. The method of claim 1, wherein the real-time first student-specific data comprises real-time data from the first biological sensor.

5. The method of claim 1, wherein the real-time first student-specific data comprises real-time social media data.

6. The method of claim 1, further comprising, by the question-generating server:
parsing the real-time first student-specific data to determine a third subset of the real-time first student-specific data that belongs to the information category that corresponds with the question variable;
retrieving a third context value from the third subset of the real-time first student-specific data;
determining an interest ranking for each of the first context value and the third context value based on the real-time first student-specific data; and
wherein automatically generating a first finalized question comprises:
determining that the first context value has a higher interest ranking than the third context value; and
replacing the question variable in the annotated question with the first context value based on the first context value having the higher interest ranking than the third context value.

7. The method of claim 6, wherein the interest ranking is based on one or more of how recent in time the first subset of the real-time first student-specific data was generated, a relation of the first context value to a topic selected by the first student as interesting, a topic frequently viewed or commented on by the first student, how frequently the first context value occurs in the real-time first student-specific data, or one or more combinations thereof.

8. The method of claim 1, further comprising, by the question-generating server:
determining a dependency between the first context value and one of a previously substituted context value or the question variable; and
wherein automatically generating a first finalized question comprises replacing the question variable in the annotated question with the first context value based on the dependency.

9. A non-transitory computer-readable medium containing instructions that, when executed by a processor, are configured to cause the processor to perform one or more operations, the operations comprising:
obtaining an annotated question, the annotated question including a question variable as part of the annotated question, the question variable including an attribute defining an information category that correspond with the question variable, obtaining the annotated question comprising:
receiving a standard question;
parsing the standard question word by word to determine a portion of the standard question to be replaced with a context value;
determining the attribute of the question variable based on the portion of the standard question to be replaced with the context value; and
replacing the portion of the standard question with the question variable based on the determination of the portion to be replaced in order to derive the annotated question;
for a first student:
receiving real-time first student-specific data of a first student from one of social media data, a first biological sensor connected to the first student, or a first global positioning system (GPS);
parsing the real-time first student-specific data to determine a first subset of the real-time first student-specific data that belongs to the information category that corresponds with the question variable;
retrieving a first context value from the first subset of the real-time first student-specific data;
automatically generating a first finalized question by replacing the question variable in the annotated question with the first context value, the first context value selected based on the information category;
providing the first finalized question to the first student; and
electronically storing a first response of the first student to the first finalized question to be used in a later question;
for a second student:
receiving real-time second student-specific data of a second student from one of social media data, a second biological sensor connected to the second student, or a second GPS;
parsing the real-time second student-specific data to determine a second subset of the real-time second student-specific data that belongs to the information category that corresponds with the question variable;
retrieving a second context value from the second subset of the real-time second student-specific data;
automatically generating a second finalized question by replacing the question variable in the annotated question with the second context value, the second context value selected based on the information category;
providing the second finalized question to the second student; and
electronically storing a second response of the second student to the second finalized question to be used in the later question; and
wherein the first finalized question and the second finalized question are electronically generated simultaneously and are different based on differences between the real-time first student-specific data and the real-time second student-specific data.

10. The non-transitory computer-readable medium of claim 9, wherein:
the annotated question includes a plurality of question variables and each of the plurality of question variables has a respective attribute defining a respective information category to which each of the plurality of question variables belongs; and
each of the plurality of question variables is replaced by one of a plurality of context values in the respective information category.

11. The non-transitory computer-readable medium of claim 10, the operations further comprising sorting the plurality of context values into a plurality of information categories, the plurality of information categories including the respective information category.

12. The non-transitory computer-readable medium of claim 9, wherein the first real-time student-specific data is the real-time data from the first biological sensor.

13. The non-transitory computer-readable medium of claim 9, wherein the real-time first student-specific data is the real-time social media data.

14. The non-transitory computer-readable medium of claim 9, the operations further comprising:
parsing the real-time first student-specific data to determine a third subset of the real-time first student-specific data that belongs to the information category that corresponds with the question variable;
retrieving a third context value from the third subset of the real-time first student-specific data;
determining an interest ranking for each of the first context value and the third context value based on the real-time first student-specific data; and
wherein automatically generating a first finalized question comprises:
determining that the first context value has a higher interest ranking than the third context value; and
replacing the question variable in the annotated question with the first context value based on the first context value having the higher interest ranking than the third context value.

15. The non-transitory computer-readable medium of claim 14, wherein the interest ranking is based on one or more of how recent in time the first subset of the real-time first student-specific data was generated, a relation of the first context value to a topic selected by the first student as interesting, a topic frequently viewed or commented on by the first student, how frequently the first context value occurs in the real-time first student-specific data, or combinations thereof.

16. The non-transitory computer-readable medium of claim 9, the operations further comprising:
determining a dependency between the first context value and one of a previously substituted context value or the question variable; and
wherein automatically generating a first finalized question comprises replacing the question variable in the annotated question with the context value based on the dependency.

17. A system comprising:
a content server comprising a data storage storing a first context value and a second context value; and
a question-generating server comprising:
a processor; and
a computer-readable medium containing instructions that, when executed by the processor, are configured to cause the question-generating server to perform one or more operations, the operations comprising:
obtaining an annotated question, the annotated question including a question variable as part of the annotated question, the question variable including an attribute defining an information category that correspond with the question variable, obtaining the annotated question comprising:
receiving a standard question;
parsing the standard question word by word to determine a portion of the standard question to be replaced with a context value;
determining the attribute of the question variable based on the portion of the standard question to be replaced with the context value; and
replacing the portion of the standard question with the question variable based on the determination of the portion to be replaced in order to derive the annotated question;
for a first student:
requesting a first context value associated with the first student from the content server and belonging to the information category;
receiving the first context value from the content server, the first context value derived from real-time first student-specific including one of real-time social media data, real-time data from a first biological sensor connected to the first student, or a first global positioning system (GPS);
automatically generating a first finalized question by replacing the question variable in the annotated question with the first context value;
providing the first finalized question to the first student; and
transmitting a first response of the first student to the first finalized question to the content server to be electronically stored for use in a later question;
for a second student:
requesting a second context value associated with the second student from the content server and belonging to the information category;
receiving the second context value from the content server, the second context value derived from real-time second student-specific including one of real-time social media data, real-time data from a second biological sensor connected to the second student, or a second GPS;
automatically generating a second finalized question by replacing the question variable in the annotated question with the second context value;
providing the second finalized question to the second student; and
transmitting a second response of the second student to the second finalized question to the content server to be electronically stored for use in the later question;
wherein the first finalized question and the second finalized question are electronically generated simultaneously and are different based on differences between the real-time first student-specific data and the real-time second student-specific data.

18. The system of claim 17, wherein:
the annotated question includes a plurality of question variables and each of the plurality of question variables has a respective attribute defining a respective information category to which each of the plurality of question variables belongs; and
each of the plurality of question variables is replaced by one of a plurality of context values in the respective information category.

19. The system of claim 17, wherein the content server stores the plurality of context values in a plurality of information categories, the plurality of information categories including the respective information category.

20. The system of claim 17 wherein the first real-time student-specific data is the real-time data from the first biological sensor and is generated within thirty seconds of the first finalized question being generated.
